(19) United States
(12) Patent Application Publication
(10) Pub. No.: US 2005/0198775 A1
(43) Pub. Date: Sep. 15, 2005

(54) Spring balance assembly

(76) Inventors: Dean Pettit, St. John, IN (US); Vincent F. Eslick, Chicago, IL (US)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 11/067,508

(22) Filed: Feb. 25, 2005

Related U.S. Application Data
(60) Provisional application No. 60/548,316, filed on Feb. 27, 2004.

(51) Int. Cl. E05D 15/22

(52) U.S. Cl. 16/197

(57) ABSTRACT

The present invention provides a balance assembly for use with a sash window assembly slidable within a master frame. The balance assembly generally includes a plate, a spring assembly, and a brake shoe or pivot brake assembly. The plate is removably connected to the master frame. The spring assembly includes a first spring that is inter-wound or nested within a second spring. Each spring has a coiled portion, an intermediate portion, and a free portion. The coiled portions of the springs are rotatably supported by the support member that extends from the plate. The free portions of the springs have a curved configuration and are received by a slot in the brake shoe, which is operably coupled to the sash window. The inter-wound springs exert a balancing force on the sash window during movement of the window.

### CROSS-REFERENCE TO RELATED APPLICATIONS

This application claims the benefit of U.S. Provisional Patent Application No. 60/548,316, filed Feb. 27, 2004, which is expressly incorporated herein by reference.

### FEDERALLY SPONSORED RESEARCH OR DEVELOPMENT

Not applicable.

### TECHNICAL FIELD

The present invention relates to a spring balance assembly for a sash window. More specifically, the present invention relates to a spring balance assembly having inter-wound or nested coil springs that are secured to a pivot brake assembly.

### BACKGROUND OF THE INVENTION

Sash windows disposed within a master frame are quite common. Generally, the master frame includes a pair of opposed vertical guide rails, an upper horizontal member or header, and a lower horizontal member or base. The guide rails are designed to slidingly guide at least one sash window within the master frame. Double hung sash windows have an upper sash window and a lower sash window. The guide rails of the master frame define an elongated channel. To counterbalance the sash window during movement of the window, a spring balance assembly is affixed to the master frame in the elongated channel and connected to the sash window. Spring balance assemblies generally provide an upward biasing force to the sash window to aid its movement within the master frame.

One conventional balance assembly includes a support plate, a plurality of coil springs, and a pivot brake assembly or brake shoe. The plate has multiple structures to rotatably support the coil springs in a stacked configuration, wherein there is a top or upper spring and a bottom or lower spring. The stacked configuration of the coil springs causes the plate to be dimensioned with a length sufficient to adequately support the springs and permit rotation of the springs. Each spring has a coiled portion and a free portion. Typically, the free portions of the springs are linear and include an aperture. The pivot brake assembly includes a housing having at least one aperture adapted to receive a threaded fastener. When the conventional spring brake assembly is in the assembled position, the springs are secured to the pivot brake assembly by the fastener. Thus, the free portions of the top and bottom springs are attached to the housing of the pivot brake assembly by a fastener passing through the aperture in the free portion of the springs and into the aperture of the housing.

Conventional spring balance assemblies have certain limitations. One such limitation is that stacked coil springs have a greater stack height which requires a support plate with increased dimensions, such as length. A longer support plate typically increases material costs, and reduces the egress of the sash window within the master frame since in addition to other limitations, the balance assembly must be mounted a greater distance below the header of the master frame. Another limitation of conventional balance assemblies is found in the manner in which the top and bottom coil springs are connected to the pivot brake assembly. The use of a fastener(s) requires additional material, labor and time during assembly of the spring balance. Therefore, there is a tangible need for a spring balance assembly with nested coil springs and that does not require a fastener to secure the coil spring to the pivot brake assembly.

The present invention is provided to solve the problems discussed above and other problems, and to provide advantages and aspects not provided by prior balance assemblies of this type. A full discussion of the features and advantages of the present invention is deferred to the following detailed description, which proceeds with reference to the accompanying drawings.

### SUMMARY OF THE INVENTION

The present invention relates to a balance assembly for use with a sash window assembly. According to a first aspect of the invention, the balance assembly comprises a plate, a spring assembly, and a shoe or pivot brake assembly. The spring assembly includes a first coil spring and a second coil spring wherein the springs are inter-wound or nested. Each coil spring has a coiled portion, an intermediate portion, and a curvilinear free portion with a free end. The shoe includes at least one slot with a curved segment that receives the curvilinear free portion of the spring. The plate has a support member that extends from the plate and rotatably supports the spring assembly without binding or inhibiting the rotation of either spring. The plate has at least one opening that is adapted to receive a fastener to secure the plate to a master frame of the sash window assembly. Preferably, the opening passes through an extent of the support member. To connect the coil springs to the pivot brake assembly, the curvilinear free portion of each spring is received by the slot of the pivot brake assembly.

According to another aspect of the invention, the pivot brake assembly is operably connected to a lower portion of the sash window. When the pivot brake assembly is coupled to the sash window, the balance assembly counterbalances the weight of the sash window wherein the first and second springs exert a generally upward force on the sash window. The pivot brake assembly comprises a housing, a cam, and a brake pad. The housing includes a front wall, a rear wall, a bottom wall, and two sidewalls. The housing has a chamber passing through the front wall and rear wall of the housing. The chamber is adapted to receive the cam. The housing further includes a pair of openings adapted to receive and retain the brake pad. The housing further has a central cavity defined generally between the first and second sidewalls and opposite the bottom wall.

According to another aspect of the invention, the housing of the pivot brake assembly has two slots. Alternatively, the pivot brake assembly includes a single slot. Each slot is positioned between one of the sidewalls and the central cavity. Each slot has a first end terminating within the housing and a generally opposing second end proximate the sidewall. The slots each have a curved portion between the first end and the second end. Preferably, the curved portion is in communication with the first end of the slot. The curved portion of each slot defines a first protrusion. Each slot is adapted to receive at least an extent of the free portion of either or both of the coil springs. Consequently, the slots are cooperatively dimensioned with the free portions of the coil springs.

According to yet another aspect of the invention, when the balance assembly of the present invention is in the assembled position, the first spring is secured to the pivot brake assembly by engagement between the free portion of the first spring and the curved portion of the first slot. Similarly, the second spring is secured to the pivot brake assembly by engagement between the free portion of the second spring and the curved portion of the first slot. Thus, both springs are secured to the pivot brake assembly without the use of any fasteners. Although both springs may be installed in the same slot, it is also understood that other configurations are possible without departing from the spirit of the present invention. Furthermore, in the assembled position, the free end of the first spring is positioned adjacent to the free end of the second spring. Similarly, the coiled portion of the first spring is positioned adjacent to the coiled portion of the second spring.

The spring balance assembly of the present invention provides a number of significant advantages over conventional balance assemblies. First, the inter-wound coil springs of the spring assembly allow for a reduction in the dimensions of the plate while maintaining the same biasing force applied to the sash window. This enables the balance assembly to be mounted higher in the channel which increases the egress of the sash window. In addition and due to the configuration of the slots and the free portions, the springs are retained by the pivot brake assembly without the use of any fasteners. As a result, assembly and disassembly of the spring balance assembly can be accomplished significantly faster. Consequently, the spring balance assembly of the present invention offers cost-savings benefits as well as increased versatility, adjustability, and ease of assembly. Other features and advantages of the invention will be apparent from the following specification taken in conjunction with the following drawings.

### BRIEF DESCRIPTION OF THE DRAWINGS

FIG. 1 is a perspective view of a spring balance assembly of the present invention, showing the spring balance assembly connected to a master frame, the master frame partially shown for clarity;

FIG. 2 is a partially exploded view of the spring balance assembly of FIG. 1, showing a plate, a spring assembly and a pivot brake assembly;

FIG. 3 is an exploded view of the plate and the spring assembly of the spring balance assembly of FIG. 1;

FIG. 4 is a front elevation view of the spring balance assembly of FIG. 1;

FIG. 5 is a rear elevation view of the spring balance assembly of FIG. 1;

FIG. 6 is a side elevation view of the spring balance assembly of FIG. 1;

FIG. 7A is a front elevation view of the spring balance assembly mounted to a sash window assembly wherein the window assembly is shown in a closed position; and,

FIG. 7B is a front elevation view of the spring balance assembly mounted to a sash window assembly wherein the window assembly is shown in an open position.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

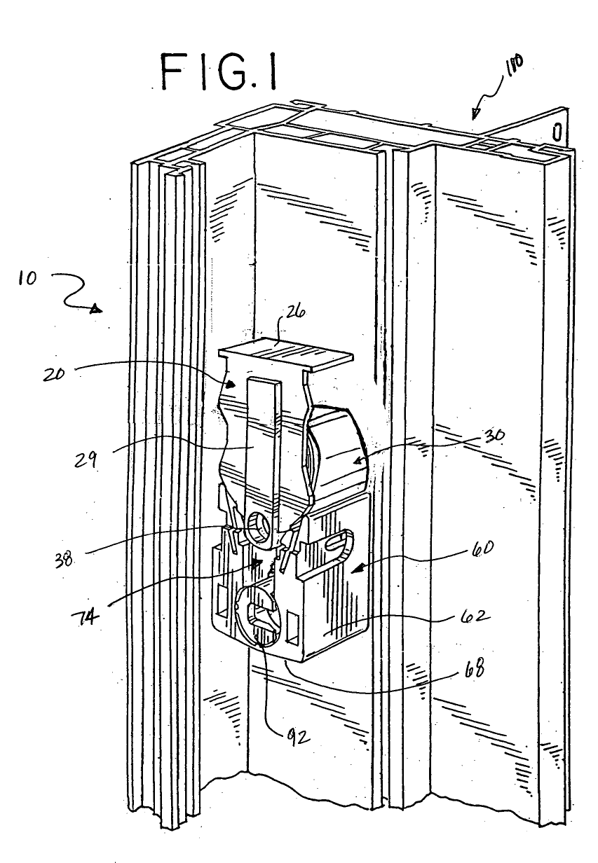

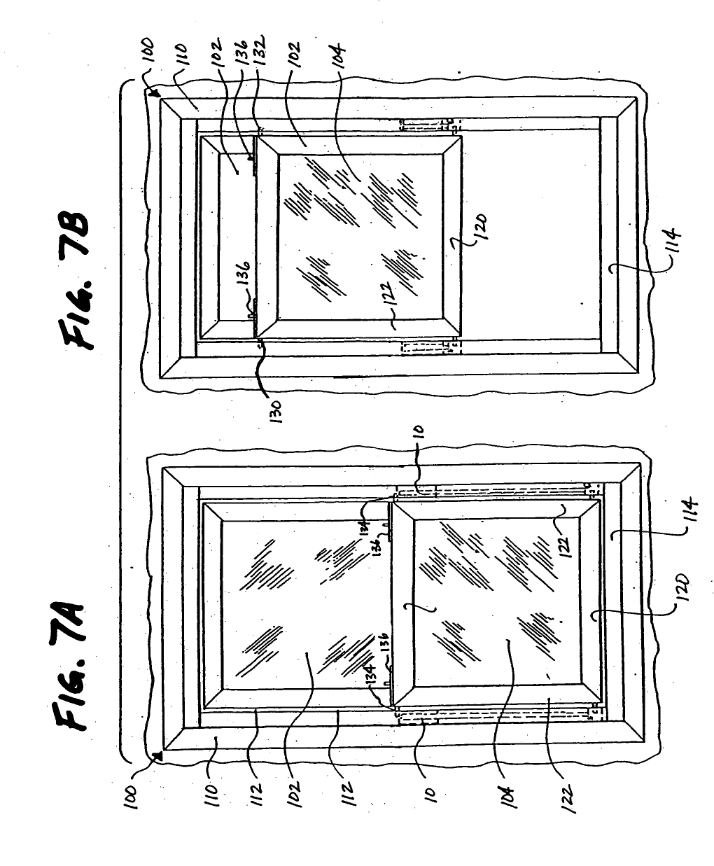

Referring to FIGS. 1, 7A, and 7B, a balance assembly 10 is affixed to a sash window assembly 100. The sash window assembly 100 shown in FIG. 7 is a double-hung window assembly having an upper pivotal sash window 102 and a lower pivotal sash window 104 in a master frame 110. In general terms, the master frame 110 includes a pair of opposed vertical guide rails 112 adapted to slidably guide the sash windows 102, 104. The master frame further includes a footer or lower horizontal element 114. The guide rail 112 defines an elongated channel 116 in which the spring balance assembly 10 is mounted. Typically, the master frame 110 has a set of guide rails 112 for each sash window 102,104 and the balance assembly 10 is mounted to each guide rail 112 to balance the sash window 102, 104. The sash window 104 has a top rail 118, a base rail 120, and a pair of stiles or side rails 122. A tilt latch 130 is mounted in an upper portion of the top rail 118. The tilt latch 130 has a bolt 132 with a nose portion 134 adapted to extend into the elongated channel 116. The tilt latch 130 has an actuator 136 and a spring (not shown) wherein the actuator 136 is designed to retract the bolt 132 into the housing of the latch 130 against the biasing force of the spring.

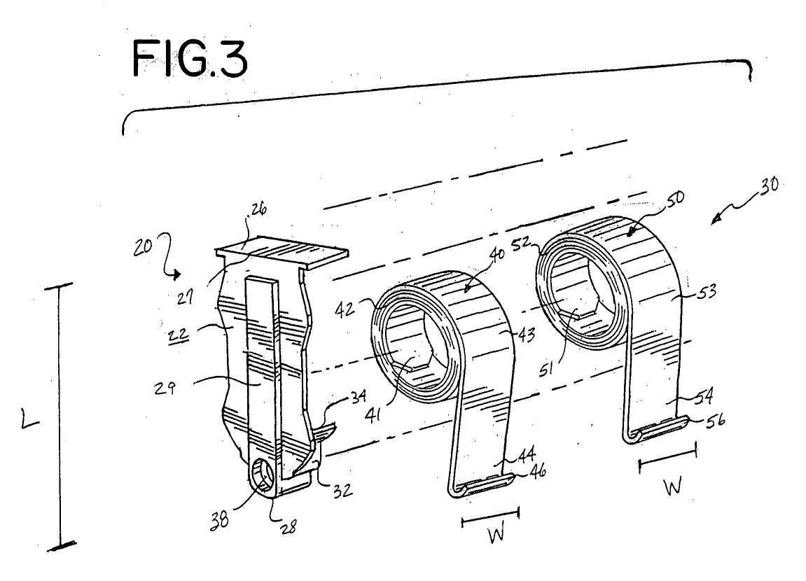

As shown in FIGS. 1-6, the balance assembly 10 generally includes a plate or holder 20, a spring assembly 30, and a shoe or pivot brake assembly 60. The spring assembly 30 includes a first coil spring 40 and a second coil spring 50 wherein one of the springs 40, 50 is inter-wound within the other spring 40, 50. Described in a different manner, one of either the first spring 40 or the second spring 50 is nested within the other of the first spring 40 or the second spring 50. One of skill in the art recognizes that either spring 40, 50 can be nested within the other spring 40, 50. One of skill in the art further recognizes that the first and second springs 40, 50 remain operational when inter-wound or nested. Although FIGS. 1-6 depict the spring assembly 30 as having two coil springs 40, 50, the spring assembly 30 can have additional coil springs. For example, the spring assembly 30 can include a third coil spring (not shown). Referring to FIG. 3, each coil spring 40, 50 has a width W. Depending upon the design parameters of the balance assembly, the coil spring widths W can be equal or dissimilar.

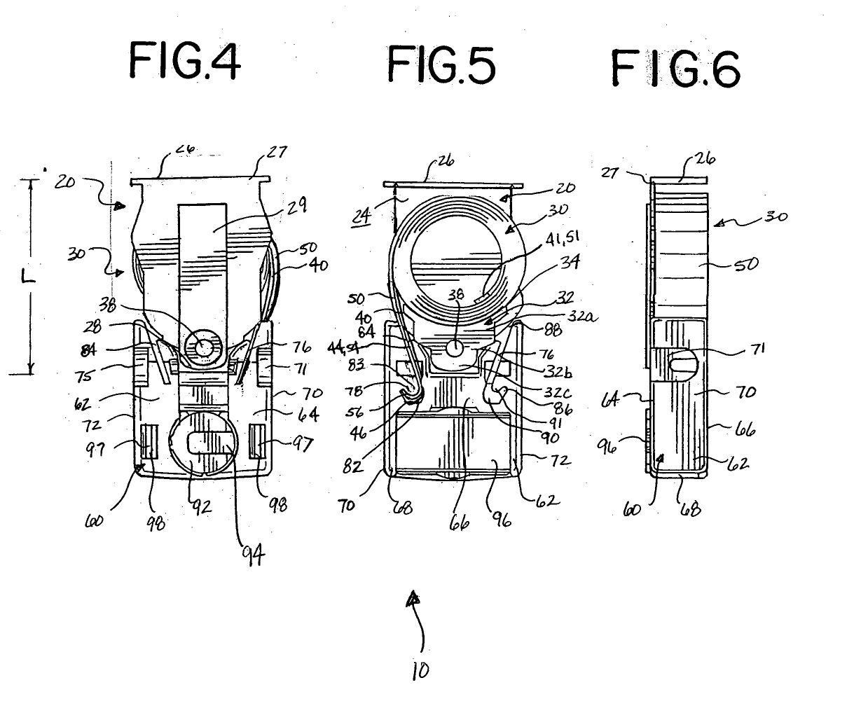

In general terms, the plate 20 rotatably supports or holds the spring assembly 30 while the first and second springs 40, 50 are coupled to the pivot brake assembly 60. The plate 20 has an outer surface 22, an inner surface 24, and a top wall 26. The plate 20 further has an upper edge 27 and a lower edge 28. The outer surface 22 of the plate 20 extends between the upper edge 27 and the lower edge 28, and faces towards the sash window 104 when the balance assembly 10 is mounted to the guide rail 112 of the master frame 110. The inner surface 24 of the plate 20 extends between the upper edge 27 and the lower edge 28, and is oriented towards the channel 116 when the balance assembly 10 is mounted to the guide rail 112 of the master frame 110. The top wall 26 extends from the upper edge 27 of the plate 20 and towards an inner surface 117 of the channel 116. The outer surface 22 of the plate 20 has a raised strip 29 which extends along the outer surface 22 substantially between the upper edge 27 and the lower edge 28. The raised strip 29 is adapted to increase the structural rigidity of the plate 20 and balance assembly 10. The strip 29 can include indicia that reflects the size and/or rating of the coil springs 40, 50. The plate 20 has a length L (see FIGS. 3 and 4), thickness, and width which can be varied depending upon the design parameters of the balance assembly 10.

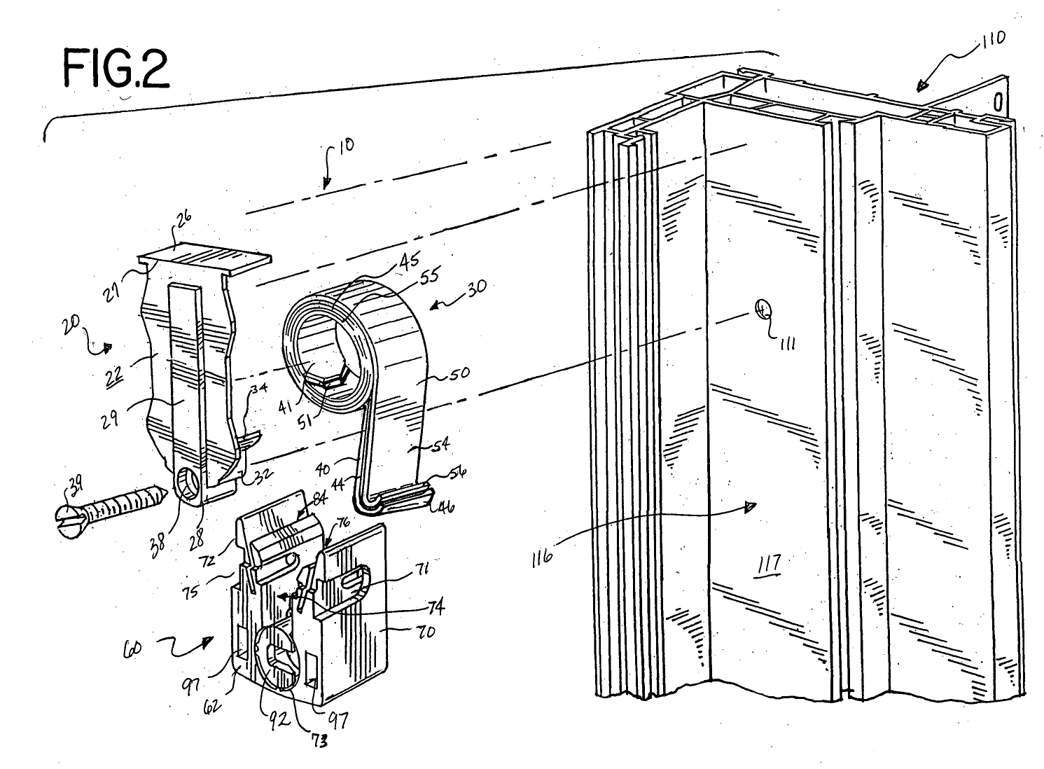

As shown in FIGS. 2-6, the inner surface 24 of the plate 20 has a support member 32 that extends generally perpendicular from the inner surface 24. Thus, the support member 32 extends towards the inner surface 117 of the channel 116 when the balance assembly 10 is installed. The support member 32 rotatably supports the spring assembly 30 without binding or inhibiting the rotation of the springs 40, 50. The support member 32 has an upper portion 32a, an intermediate portion 32b, and a base portion 32c which provide the support member 32 with a stepped or notched appearance. The upper portion 32a of the support member 32 has a curvilinear configuration that defines a concave supporting surface 34. The support surface 34 of the second member 32 is adapted to contact and rotatably support the spring assembly 30. As shown in FIGS. 2 and 5, the support member 32 is positioned to rotatably engage an outer periphery or outer surface of either the first or second spring 40, 50. Described in a different manner, the support member 32 is not located within the internal region or spool 45, 55 of the coil springs 40, 50. As a result, the support member 32 is positioned beyond the circumference of the coil springs 40, 50, or the support member 32 can be considered as being spaced from the internal regions defined by the coiled portions of the coil springs 40, 50. Preferably, the upper portion 32a (and the resulting support surface 34) has a curvilinear configuration to provide increased support to the springs 40, 50. However, it is understood that the shape of each of the member 32, including the upper portion 32a can assume different configurations so long as the member 32 rotatably supports the spring assembly 30.

In addition, the plate 20 has at least one opening 38 which is adapted to receive a fastener 39. The opening 38 extends through an extent of the support member 32. Preferably, the opening 38 passes through an extent of the intermediate and base portions 32b, 32c of the support member 32. However, it is understood that the opening 38 can be located elsewhere on the plate 20 without departing from the spirit of the present invention. Thus, the location of the opening 38 can be varied depending upon the design parameters of the balance assembly 10. The fastener 39 is inserted into the opening 38 to secure the plate 20 of the balance assembly 10 to the master frame 110 within the channel 116. An extent of the fastener 39 is received by an aperture 111 in the master frame 110. Note that the guide rail 112 has been omitted from the master frame 110 in FIGS. 1 and 2 for illustrative purposes. The fastener 39 can be a screw, rivet, or any elongated structure capable of securing the balance assembly 10 to the master frame 110. Alternatively, the fastener 39 and the opening 38 are omitted, and the plate 20 has at least one extending projection (not shown) that is received by an opening in the frame 110 to secure the balance assembly 10 thereto.

As mentioned above, the first coil spring 40 of the spring assembly 30 is inter-wound with the second coil spring 50. Referring to FIG. 3, the first spring 40 has a terminal end 41, a coiled portion 42, an intermediate portion 43, and a free portion 44. The coiled portion 42 of the first spring 40 forms a spool 45 which is rotatably supported by the first support member 30. The terminal end 41 of first spring 40 is located within the spool 45 formed by the coiled portion 42 of the first spring 42. The free portion 44 of the first spring 40 has a curvilinear configuration with a curved or rolled free end 46. The free portion 44 partially engages a portion of the pivot brake assembly 60. The second spring 50 has a terminal end 51, a coiled portion 52, an intermediate portion 53, and a free portion 54. The coiled portion 52 of the second spring 50 forms a spool 55 which is rotatably supported by the second support member 32. It is understood that additional support structures, such as a separate spool or a center support member could be positioned within the coiled portion 32. The terminal end 51 of the second spring 50 is located within the spool 55 formed by the coiled portion 52 of the second spring 50. The free portion 54 of the second spring 50 has a curvilinear configuration with a curved or rolled free end 56. Preferably, the free ends 46, 56 are cooperatively dimensioned to permit their engagement as shown in FIG. 2. As detailed below, the free portion 54 partially engages a portion of the pivot brake assembly 60. When viewed in cross-section, the free portions 44, 54 have a “J-shaped” configuration that defines a tab or hook. It is understood that the free portions 44, 54 can have other curvilinear or angular configurations, such as “L-shaped.”

Since the spring assembly 30 features nested or inter-wound springs, the first and second springs 40, 50 are in close proximity. Therefore, the support member 32 rotatably engages the outer surface of the second spring 50 when the sash window assembly 100 is moved between open and closed positions. As shown in FIG. 2, the free portion 44 of the first spring 40 is positioned adjacent to the free portion 54 of the second spring 50. The free end 46 of the first spring 40 is positioned adjacent to the free end 56 of the second spring 50. Near the free ends 46, 56, the outer surface of the first spring 40 is positioned adjacent the inner surface of the second spring 50. As explained below, this positional relationship enables the free ends 46, 56 to be jointly received by a portion of the pivot brake assembly 60. In addition, the coiled portion 42 of the first spring 40 and the coiled portion 52 of the second spring 50 are nested. Lastly, the terminal end 41 of the first spring 40 is positioned adjacent to the terminal end 51 of the second spring 50. Near the terminal ends 41, 51, an outer surface of the first spring 40 is positioned adjacent an inner surface of the second spring 50. Similarly, the spring assembly 30 is sized in accordance with the biasing force necessary for slidable movement of the sash window 102. Therefore, the first and second springs 40, 50 are sized to provide a sufficient biasing force; however, the springs 40, 50 remain nested during rotatable movement of the spring assembly 30.

The shoe or pivot brake assembly 60 is operably connected to both the first and second springs 40, 50. In addition, the pivot brake assembly 60 is operably connected to a lower portion of the sash window 104 near the base rail 120. When the pivot brake assembly 60 is coupled to the sash window 104, the balance assembly 10 counterbalances the weight of the sash window 104 wherein the first and second springs 40, 50 exert a generally upward force on the sash window 104 when it is moved between the closed and open positions of FIGS. 7A and 7B. The pivot brake assembly 60 generally includes a housing 62, a cam 92, and a brake pad 96 (see FIGS. 2 and 4-6). The housing 62 of the pivot brake assembly 60 receives and supports the cam 92, and the brake pad 96. It is understood that the pivot brake assembly 60 can be a shoe which does not include a brake pad 96 such as for a non-tiltable sash window.

The housing 62 of the pivot brake assembly 60 includes a front wall 64, a rear wall 66, a bottom wall 68, and two sidewalls 70, 72. The front wall 64, rear wall 66, bottom wall 68 and sidewalls 70, 72 cooperate to form the housing 62. As seen in FIG. 2, the housing 62 has a chamber 73 passing through the front wall 64 and rear wall 66 of the housing 62. Preferably the chamber 73 is proximate the bottom wall 68 of the housing 62. The chamber 73 preferably has a generally cylindrical configuration, and is adapted to receive the cam 92. Each of the side walls 70, 72 have a recessed portion 71, 75. The housing further includes a pair of openings 97 adapted to receive and retain the brake pad 96. Each opening 97 passes through the front wall 64 and rear wall 66 of the housing 62. The housing 62 further has a central cavity 74 defined generally between the first and second sidewalls 70, 72, and opposite the bottom wall 68. Thus, the chamber 73 is located between the central cavity 74 and the bottom wall 68.

Preferably, the housing 62 of the pivot brake assembly 60 further includes two slots 76, 84, as shown in FIGS. 2, 4 and 5. Alternatively, the pivot brake assembly 60 includes a single slot 76. The first slot 76 is positioned between the first sidewall 70 and the central cavity 74, while the second slot 84 is positioned between the second sidewall 72 and the central cavity 74. The first slot 76 has a first end 78 (see FIG. 5) terminating within the housing 62, and a generally opposing second end 80, proximate the first sidewall 70. Also, the first slot 76 has a curved portion 82 between the first end 78 and the second end 80. Preferably, the curved portion 82 of the first slot 76 is in communication with the first end 78 of the first slot 76. The curved portion 82 of the slot 76 defines a first protrusion 83. Similarly, the second slot 84 has a first end 86 terminating within the housing 62, and a generally opposing second end 88 proximate the second sidewall 72. The second slot 84 has a curved portion 90 between the first end 86 and the second end 88. Preferably, the curved portion 90 of the second slot 84 is in communication with the first end 86 of the second slot 84. The curved portion 90 of the slot 84 defines a second protrusion 91. In general terms, each slot 76, 84 is adapted to receive at least a portion of the free portion 44, 54 of either or both coil springs 40, 50. Consequently, the slot 76, 84 is cooperatively dimensioned with the free portion 44, 54 of the coil springs 40, 50. Thus, it is understood that the slots 76, 84 are configured to correspond to the configuration of the free portions 44, 54 of the springs 40, 50. In the event that the spring assembly 30 includes three coil springs, each slot 76, 84 is configured to receive the free portions of all three springs.

Additionally, it is preferable that the slots 76, 84 do not pass through the entire housing 62. As seen in FIGS. 4 and 5, while both slots 76, 84 are accessible from the rear wall 66, only a portion of the slots 76, 84 are viewable from the front wall 64. Described in a different manner, the front wall 64 of the housing 62 covers at least a portion of the slots 76, 84 while the slots 76, 84 are open to the rear wall 66 of the housing. The front wall 64 covering a portion of the slots 76, 84 assists in retaining the free portions 44, 54 of the coil springs 40, 50 when the balance assembly 10 is installed. Alternatively, the front wall 64 does not cover the slots 76, 84 and the slots 76, 84 extend through the housing 62. Consequently, the slots 76, 84 are visible from the front wall 64. Alternatively, the slot 76, 84 is resiliently reclosable whereby there is an interference fit between the slot 76, 84 and the free portion 44, 54. In this manner, there is a “squeezing” of the free portion 44, 54 by the slot 76, 84 to maintain the free portion 44, 54 therein.

The cam 92 is cooperatively dimensioned to be installed in the chamber 73. The cam 92 and chamber 73 are configured so that the cam 92 can pass into the chamber 73 only through the rear wall 66 of the housing 62. Furthermore, the cam 92 and chamber 73 are configured so that once the cam 92 is installed in the chamber 73, the cam 92 cannot pass out of the front wall 64 of the housing 62. Thus, once installed, the cam 92 can only be removed from the chamber 73 through the rear wall 66 of the housing 62. The cam 92 further includes a receiver 94 in communication with the front wall 64 of the housing 62. The receiver 94 is cooperatively dimensioned to engage a portion of the sash window 104.

The brake pad 96 contacts and slides along the inner surface 117 of the channel 116 in the master frame 110 providing resistance against uncontrolled sliding of the sash window 104 in the master frame 110. The brake pad 96 includes a pair of fingers 98 extending generally perpendicular therefrom. Each of the fingers 98 is cooperatively dimensioned to be inserted into the openings 97 (see FIG. 2) of the housing 62. The fingers 98 are configured to engage the openings 97 in the housing 62, thereby connecting the brake pad 96 to the housing 62. Furthermore, the fingers 98 are adapted to resist disconnection from the housing 62 once engaged in the openings 97. As discussed above, the brake pad 96 can be omitted wherein the pivot brake assembly 60 may be referred to as a shoe.

When the balance assembly 10 of the present invention is in the assembled position (see FIGS. 1 and 4-6), the spring assembly 30 is operably connected to the pivot brake assembly 60. The first spring 40 is coupled to the pivot brake assembly 60 by engagement between the free portion 44 of the first spring 40 and the curved portion 82 of the first slot 76. Similarly, the second spring 50 is secured to the pivot brake assembly 60 by engagement between the free portion 54 of the second spring 50 and the curved portion 82 of the first slot 76. Specifically, during assembly, the free portions 44, 54 of both springs 40, 50 are inserted into the first slot 76 through the rear wall 66 of the housing 62 such that at least a portion of the free portions 44, 54 engage the protrusion 83. This engagement retains the free portions 44, 54 in the slot 76. Thus, both springs 40, 50 are secured to the pivot brake assembly 60 without the use of any fasteners. Alternatively, an elongated fastener (not shown) is used to secure the first and second springs 40, 50 to the pivot brake assembly 60 by extending through the side wall 70 and into an opening in the free end portion 44, 54.

In the assembled position of FIGS. 1 and 4-6, an extent of the spring assembly 30 slidingly engages the support member 32. Depending upon which spring 40, 50 is nested within the other, the support surface 34 slidingly engages either the coiled portion 42 of the first spring 40 or the coiled portion 52 of the second spring 50. The plate 20 is attached to the master frame 110 of the sash window assembly 100 by the fastener 39 that passes through the opening 38 in the plate 20 and engage corresponding apertures 111 in the master frame 110, such that the springs 40, 50 remain nested and positioned within the channel 116. Thus, the springs 40, 50 are enclosed between the inner surface 24 of the plate 20 and the inner surface 117 of the channel 116. The pivot brake assembly 60 is then attached by engaging the sash window 104 with the receiver 94 of the cam 92. When the sash window 104 is moved between open and closed positions, the coil springs 40, 50 wind and unwind in the same rotational direction. Referring to FIG. 5, the coil springs 40, 50 rotate in a counter-clockwise direction.

Although FIGS. 1 and 4-6 show the free portions 44, 54 of both springs 40, 50 installed in the same slot 76, it is also understood that other configurations are possible without departing from the spirit of the present invention. For example, the balance assembly 10 may be assembled such that the first and second springs 40, 50 are operably connected to opposite sides of the pivot brake assembly 60. In this example, the first spring 40 is secured to the pivot brake assembly 60 by engagement between the free portion 44 of the first spring 40 and the first protrusion 83 of the first slot 76, while the second spring is secured to the pivot brake assembly 60 by engagement between the free portion 54 of the second spring 50 and the second protrusion 91 of the second slot 84. Thus, unlike FIG. 5 where both free portions 44, 54 are installed in the same slot 76, 84, in this configuration, the free portions 44, 54 are installed in separate slots 76, 84. During assembly, the free portion 44, 54 of each spring 40, 50 is inserted into its respective slot 76, 84 through the rear wall 66 of the housing 62 such that at least a portion of the free portion 44, 54 engages the protrusions 83, 91 of the slot 76, 84. A portion of the free portion 44, 54 confronts the curved portion 82, 90 of the slot 76, 84 to retain the free portion 44, 54 in the slot 76, 84. Thus, both springs 40, 50 are secured to opposed sides of the pivot brake assembly 60 without the use of any fasteners. When the sash window 104 is moved between open and closed positions, the coil springs 40, 50 wind and unwind in the opposite rotational direction—one spring rotates in the clockwise direction and the other spring rotates in a counter-clockwise direction. It is understood that the nesting of the springs may be modified to accommodate this configuration.

As another example, both springs 40, 50 rotate in the same direction but are connected to opposite side of the pivot brake assembly 60 (as opposed to being connected to the same side of the assembly 60). In this configuration (not shown), one of the free portions 44, 54 of the first and second springs 40, 50 is fed through a central region of the assembly 60 to reach the opposite side of the assembly 60 for securement in the slot 76, 84. As yet another example, the pivot brake assembly 60 is configured to have a plurality of slots 76, 84 located on the same sidewall 70, 72. Therefore, the free portion 44 of the first spring 40 can is received by an upper slot 76, 84 and the free portion 54 of the second spring 50 is received by a lower slot 76, 84 that is positioned below the upper slot 76, 84.

Numerous other configurations of the balance assembly 10 exist. For example, the free portion 44 of the first spring 40 can be installed in the second slot 84, while the free portion 54 of the second spring 50 can be installed in the first slot 76. As another example, the spring assembly 40 includes two nested coil springs 40, 50 wherein the first free portion 44 is received by one of the first or second slot 76, 84 and the second free portion 54 is operably secured to the intermediate portion 43 of the spring 40 (not shown). The second free portion 54 includes a projection that is received by an opening in the intermediate portion 43 to link the inter-wound springs 40, 50. Alternatively, the opening in the second spring 50 is positioned near or within the free portion 54. While the first free portion 44 is directly connected to the pivot brake assembly 60, the second free portion 54 is indirectly connected to the brake assembly 60 via the link between the first and second springs 40, 50. It is further understood that the nesting of the springs 40, 50 may take various configurations.

In another embodiment, the plate 20 includes an elongated structure or spool (not shown) extending substantially perpendicular to the inner surface 24 of the plate 20 and through an extent of the internal region of the spring assembly 30. The elongated structure is cooperatively dimensioned with the internal region of the springs 40, 50 to provide support thereto during rotatable movement of the spring assembly 30. In this manner, the elongated structure is a central spool. The elongated structure can be tubular with a central opening dimensioned to receive a fastener that further secures the plate 20 to the master frame 110. Other spring support structures could also be utilized.

The balance assembly 10 of the present invention provides a number of significant advantages over conventional balance assemblies. First, the spring assembly 30 allows the designer to reduce the dimensions of the plate 20 while maintaining the same biasing force applied to the window 102. Since the first and second springs 40, 50 are nested or inter-wound, and not stacked as per conventional holders, the spring assembly 30 consumes less space than conventional stacked coil springs. As a result, the dimensions of the holder 10, including the length L of the plate 20 can be reduced. In contrast to conventional holders where each stacked coil spring requires a distinct support structure, the nested first and second springs 40, 50 require only one support member 32 for rotatable support. Because less space is required and only a single support member 32 is needed, the material cost and the dimensions of the plate 20 can be reduced. Reduced plate 20 dimensions enable the balance assembly 10 to be mounted higher in the channel 116 which results in greater egress of the sash window 102. The ability to mount the balance assembly 10 in a higher position increases the utility of the balance assembly 10. This benefit is understood more fully with reference to FIGS. 1, 7A and 7B. As discussed, with the inter-wound spring assembly 30, the length of the holder or plate 20 is reduced. This reduced length L allows the holder 20 to mounted in the master frame such that the lowermost position of the holder 20 is positioned at a higher location in the master frame than conventional spring holders having stacked spring configurations. As shown in FIGS. 7A and 7B, this allows the sash window to move upwardly a greater distance before the brake shoe abuts the bottom portion of the holder 20. Accordingly, egress associated with the sash window is improved.

Second, due to the configuration of the slots 76, 84 and the free portions 44, 54, the springs 40, 50 are engaged by and secured to the pivot brake assembly 60 without the use of any fasteners. As a result, assembly and disassembly of the balance assembly 10 can be accomplished significantly faster. Thus, manufacturing times of the window can be reduced since engagement of the free portions 44, 54 of the spring 40, 50 to the pivot brake assembly 60 involves only sliding the cooperatively dimensioned free portions 44, 54 into the appropriate slot 76, 84. This configuration also aids with disassembly, for example, during maintenance or repair. An individual need only slide the free portion 44, 54 of the spring 40, 50 out of the slot 76, 84 to disengage the springs 40, 50 from the pivot brake assembly 60. Furthermore, the balance assembly 10 of the present invention offers a number of cost savings. The reduced plate 20 dimensions and the lack of additional support members reduce the material costs of the balance assembly 10. Also, no apertures are required to be machined or otherwise formed in the free portions 44, 54 of the springs 40, 50. Additionally, no fasteners are required to secure the springs 40, 50 to the pivot brake assembly 60. Finally, because the free portion 44, 54 of the spring 40, 50 is free to travel across the width of the slot 76, 84 between the front wall 64 and rear wall 66 of the housing 62, the springs 40, 50 are easily adjustable. Whereas with the conventional spring balance assembly, precise location of the aperture in the spring is required to ensure proper alignment with the aperture in the housing, no such alignment concerns arise when using the balance assembly 10 of the present invention. Consequently, the balance assembly 10 of the present invention offers a multitude of cost-savings benefits as well as increased versatility, adjustability, and ease of assembly.

While the specific embodiments have been illustrated and described, numerous modifications come to mind without significantly departing from the spirit of the invention and the scope of protection is only limited by the scope of the accompanying claims.

1. A balance assembly for a sash window slidable within a master frame, the balance assembly comprising:
a holder adapted to be connected to the master frame;
a first coil spring operably connected to the holder, the first coil spring having a coiled portion and a free end portion;
a second coil spring having a coiled portion and a free end, wherein the second coil spring is nested within the first coil spring, and wherein both free end portions are adapted to be connected to the sash window.

2. The balance assembly of claim 1, wherein the holder has a support member extending from the plate to rotatably support the first and second springs.

3. The balance assembly of claim 2, wherein the support member rotatably engages an outer surface of one of the first spring and the second spring.

4. The balance assembly of claim 1, wherein the coiled portion of the first spring is positioned adjacent to the coiled portion of the second spring.

5. The balance assembly of claim 1, wherein the free end portion of the first spring is positioned adjacent to the free end portion of the second spring.

6. The balance assembly of claim 1 further comprising a brake shoe configured to be operably connected to the sash window, wherein the free portions of both springs are coupled to the brake shoe.

7. The balance assembly of claim 1, wherein the free end of each spring has a curvilinear configuration.

8. The balance assembly of claim 6, wherein the free end of each spring has a curvilinear configuration and both free ends are received by a curvilinear slot in the brake shoe.

9. A balance assembly for a sash window slidable within a master frame, the balance assembly comprising:
a plate adapted to be connected to the master frame;
a first coil spring operably connected to the plate, the first coil spring having a coiled portion;
a second coil spring having a coiled portion, wherein the second spring is inter-wound with the first spring; and,
a shoe connected to the inter-wound first and second springs.

10. The balance assembly of claim 9, wherein the plate has a support member extending from the plate to rotatably support the first and second springs.

11. The balance assembly of claim 9, wherein the first and second coil springs each have a curvilinear free end.

12. The balance assembly of claim 11, wherein the shoe has at least one slot that receives the curvilinear free end of both springs.

13. The balance assembly of claim 12, wherein the slot has a protrusion that engages and secures the free ends within the slot.

14. The balance assembly of claim 9, wherein the coiled portion of the first spring is positioned adjacent to the coiled portion of the second spring during operation of the balance assembly.

15. The balance assembly of claim 9, wherein the free portion of the first spring is positioned adjacent to the free portion of the second spring during operation of the balance assembly.

16. The balance assembly of claim 8 wherein the first coil spring has a width, and the second coil spring has a width that is different from the width of the first coil spring.

17. A balance assembly for a sash window slidable within a master frame, the sash window being operably connected to a brake shoe having a curvilinear slot, the balance assembly comprising:
a spring assembly adapted to be connected to the master frame, the spring assembly having a first coil spring with a coiled portion and a curvilinear free end, the spring assembly further having a second coil spring with a coiled portion and a free end, wherein the second spring is inter-wound with the first spring, and wherein the curvilinear free end of the first spring is configured to be received by the curvilinear slot.

18. The balance assembly of claim 17, wherein the second springs has a curvilinear free end.

19. The balance assembly of claim 18, wherein the curvilinear free end of the second spring is configured to be received by the curvilinear slot.

20. The balance assembly of claim 17, wherein a free end of the second spring is connected to the first spring near the free end of the first spring.

21. A balance assembly for a sash window slidable within a master frame, the balance assembly comprising:
a plate adapted to be connected to the master frame;
a first coil spring operably connected to the plate, the first spring having a coiled portion and a curvilinear free end;
a second coil spring having a coiled portion and a curvilinear free end, wherein the second coil spring is inter-wound with the first coil spring; and,
a brake shoe having a pair of slots, wherein each slot receives a free end of the inter-wound first and second springs.

22. The balance assembly of claim 21 wherein the plate has a support member extending from the plate, wherein the support member rotatably engages one of the first and second springs.

23. The balance assembly of claim 21 wherein each slot has a curvilinear configuration and is cooperatively dimensioned with the free end of the springs.

24. The balance assembly of claim 21 wherein the coiled portion of the first spring is positioned adjacent to the coiled portion of the second spring.

25. The balance assembly of claim 24 wherein each coiled portion has a terminal end, and wherein the terminal end of the first spring is positioned adjacent to the terminal end of the second spring.
